(19) United States
(12) Patent Application Publication
(10) Pub. No.: US 2003/0206128 A1
(43) Pub. Date: Nov. 6, 2003

(54) Remote locator

(76) Inventor: Bernard Adebayo Moore, Stockton, CA (US)

Correspondence Address: Bernard A. Moore, 3521 Fern Spring Court, Stockton, CA, 95212, US

(21) Appl. No.: 10/139,435

(22) Filed: May 6, 2002

(51) Int. Cl. H04L 17/02; G08C 19/12

(52) U.S. Cl. 341/176; 340/825.69

(57) ABSTRACT

A remote control locator that consists of a transmitter and a universal remote control as one unit. The transmitter sends a signal to a universal remote control that has a locator sensor within the confines of the remote control that has a beeper like sound as well as a light that is activated when the transmitter is used to locate the remote control. A clear colorful acrylic housing that allows the remote to have a glowing affect when activated surrounds the entire remote control. The transmitter is intended to be built within the confines of manufacturers products such as TV, VCR, stereo equipment, cable network and satellite control box.

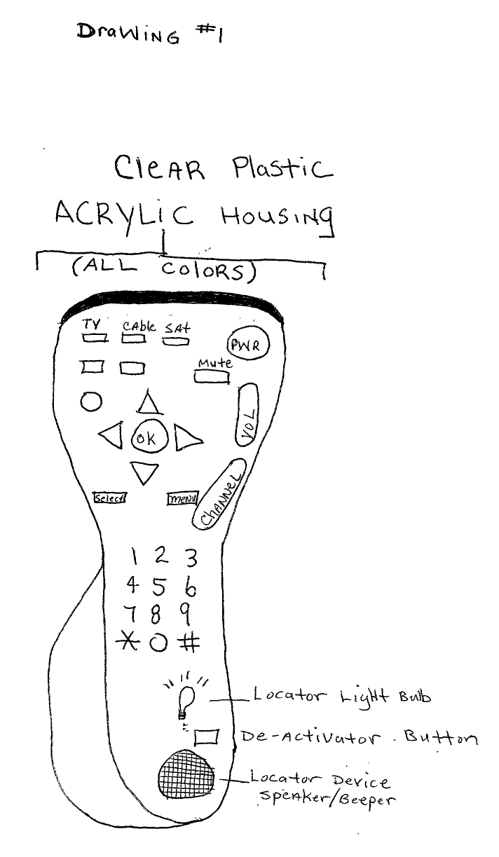

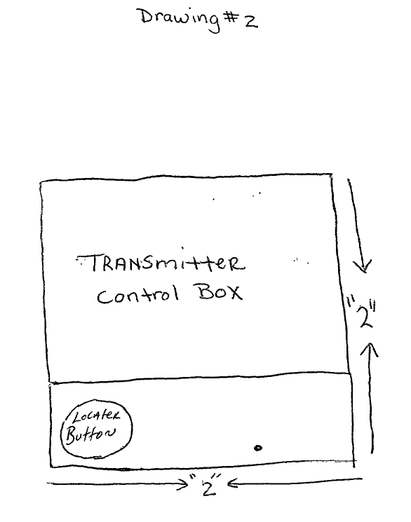

NOTE: The transmitter and remote control can also be sold as an after market for those consumers who already have the above product in their homes. The transmitter can be attached to the above products via velcro adhesive.

### COMPONENTS OF THE INVENTION

1) TRANSMITTER

2) LOCATOR DEVICE

3) LOCATOR LIGHT INDICATOR

### PURPOSE OF EACH COMPONENT

### Transmitter

The transmitter is a small device that is attached to and built within the confines of the TV, VCR, Stereo and Cable Network/Satellite control box. The transmitter will send a signal, when the user pushes the button from the base, VCR/TV Cable Network, Satellite etc. By pushing the “Locator Button”, this will activate the locator flashing light and beeper, on or within the remote control thus, allowing one to locate the remote control. Drawing #2, would be the transmitter box that will be affixed to the above mentioned items currently not equipped and will be available as an (Add On/After Market Item).

### Locator Device

The locator is a small device that is attached to or within the confines of the remote control. Once the remote control receives a signal from the transmitter by depressing the locator button on the TV/VCR, etc, it activates the remote control, which will begin to beep. It will also trigger a blinking or flashing light that allows one to locate the remote control when it is misplaced. The remote will continue to beep and flash its light until the device is located at which time, it can be deactivated by simply pressing a button on the remote itself, which will stop the device from (beeping and flashing).

### Light indicator

The light indicator is simply a light that is a part of the remote control. The light will flash while simultaneously beeping, creating a glowing effect of the entire remote control unit which allows one to locate the device by simply seeing the flashing light or, listening for the beeper which also allows the disabled, (Blind/Hearing Impaired), the ability to find the misplaced remote control. Once the remote control is located, a deactivator button is available on the remote, which will allow you to disarm the locator (stop the flashing/beeping), essentially, resetting itself for the next time the control is misplaced. (With this device, you will never lose your remote control again without the ability to locate it)!

### Note

The remote control is made of a colorful acrylic, which creates a glowing effect when the transmitter from the base/TV is activated. Or should one prefer, it is also made with the standard black plastic shell with the single locator light and beeper. The transmitter device is intended to be installed within the new televisions, VCR's, stereos etc. Additionally, as noted above, the small transmitter box is intended to be installed externally for TV's, VCR's, Stereos, Cable Networks, etc, currently not equipped with this device and can be purchased as after market equipment.

1. I claim a Transmitter/Locator button that locates remote control via sensor/signal. This claim comprises of a transmitter that sends a signal to a remote control that is used for TV, VCR, Stereo and Cable Network/Satellite control box. This particular transmitter is confined within the above mentioned manufacture products.

2. I claim a Transmitter that locates the remote control via sensor/signal. This Transmitter purpose is to be used exactly as the above-mentioned transmitter however, it is intended to be installed externally attached to the TV, VCR, Stereo, Cable Network/Satellite control box. (Can be purchased as after market equipment), for the above items currently in homes without this feature.

3. I claim a Locator device that can be located by the above transmitter via sensor/signal from the transmitter. (Placed within the confines of the remote control). This device has a beeper like sound that allows one to locate it by sound. (Helpful to the sight impaired).

4. I claim a Locator light that is within the confines of a remote control. This claim is simply a light that has the capability to turn on simultaneously when the Locator device is activated via sensor/signal from the Transmitter. (Helpful for the hearing impaired).

5. I claim the Acrylic Housing of the remote control. This claim comprises of a clear acrylic housing that comes in all colors Blue, red, green, yellow, black, and white, ect. This housing allows a glowing effect after the transmitter sends a signal to the locator device/light.

6. With this device, you'll never lose your remote control without the capability to locate it!
